(19) United States
(12) Patent Application Publication
(10) Pub. No.: US 2026/0023790 A1
(43) Pub. Date: Jan. 22, 2026

(54) DETECTING SIGNAL EXPLOITATION FROM CONSISTENT RANKING PATTERNS

(71) Applicant: GOOGLE LLC, Mountain View, CA (US)

(72) Inventors: Aditya Mayank Shah, Round Rock, TX (US); Ryan Hartsock Moulton, Sunnyvale, CA (US); Ildar Akhmedyanov, Campbell, CA (US); Ramesh Reddy Amereddy, San Francisco, CA (US); Jacob Nathaniel Scott, Los Gatos, CA (US); Benoit Zhong, Zurich (CH); Walker Nathaniel Gorell Ravina, Brooklyn, NY (US); William Nathaniel Bell, Seattle, WA (US)

(21) Appl. No.: 18/779,962

(22) Filed: Jul. 22, 2024

(51) Int. Cl. G06F 16/908; G06F 16/9538

(52) U.S. Cl. CPC G06F 16/908; G06F 16/9538

(57) ABSTRACT

Disclosed implementations for detecting exploitation of ranking signals used to provide search results. An expected value for a ranking signal is determined based on a plurality of resources responsive to a query. A residual value is determined by aggregating a difference between the expected value and an information retrieval score for the ranking signal across a domain, wherein the domain includes at least one of the plurality of resources. Responsive to determining the residual value is indicative of an exploit, adjust a ranking of a resource associated with the domain in a search result page, the resource responsive to a second query based on the ranking signal.

### BACKGROUND

Indexing is the process by which search systems (e.g., a search engine) organize information before a search to enable fast and accurate responses to queries. Search indexes for resources available over the Internet are generated by web crawlers that collect content from the resources (web pages, portable document format (PDF) documents, and the like) and indexers that analyze and organize the content by, for example, keywords. Crawling typically takes place on an ongoing basis so that the search index is kept up to date in near real time.

### SUMMARY

Implementations described herein detect exploitation of ranking signals used to provide search results by differentiating manipulated ranking signals from ranking signals for highly relevant results. In some implementations, search results are provided based on determination that a value of a ranking signal for a resource (e.g., a document such as a web page) is anomalously high. In some implementations, an aggregate of a difference between an expected value and an actual value of an information retrieval score for a ranking signal is used to flag domains that may be exploiting a search system or a particular pattern across the domain.

In one example implementation, exploitation of ranking signals by a domain are detected by determining an expected value for a ranking signal based on a plurality of first resources responsive to a first query; determining a residual value by aggregating a difference between the expected value and an information retrieval score for the ranking signal of a plurality of second resources provided via a domain, wherein the plurality of second resources includes at least one of the plurality of first resources; determining that the residual value is indicative of an exploit of the ranking signal on the domain; and responsive to determining the residual value is indicative of an exploit, adjusting a ranking of a resource in a search result page, the resource being associated with the domain and being responsive to a second query based on the ranking signal.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1 depicts an example architecture that can be employed to execute implementations of the present disclosure;

FIG. 2 depicts a flowchart of a non-limiting process that can be performed by implementations of the present disclosure; and

FIG. 3 is a diagram that illustrates an example of a distributed computer device that can be used to implement the described techniques.

### DETAILED DESCRIPTION

When someone conducts an online search, a search system analyzes information from a search index to deliver the most relevant and helpful results. To provide the most useful information, a search system employs complex algorithms that are based on a variety of ranking signals. These ranking signals, also referred to as ranking factors, represent characteristics of indexed information that influence the position of each result (e.g., a responsive resource, such as a web page) in a search result page. A search result page includes a plurality of search results and may include other relevant content, such as knowledge panels, rich results, and the like. Where multiple ranking signals are used to rank search results in a search result page, the ranking signals typically have weights applied. The weight(s) applied to each signal can vary depending on the nature of the query and/or the content of the web page as well as the overall domain. For example, the freshness (how new or recently updated) of content may play a bigger role in answering queries about current news topics than in answering queries about dictionary definitions.

At least one technical problem with current approaches for search systems is that ranking signals may be exploited by resource publishers to artificially increase the page ranking with respect to certain queries targeted by the resource publishers. For example, an anomalously high signal value for a web page determined by a search system could indicate that the content is exceptionally relevant for the query or that the content's creator is successfully exploiting the search system. Accordingly, implementations described herein provide at least one technical solution to these technical problems by assigning an expected information retrieval score for a ranking signal, where appropriate, to resources responsive to a query to ensure that outlier web pages and domains do not receive a benefit from exploiting a ranking signal(s). Implementations also ensure that resources and domains are not demoted lower than an expected value for the ranking signal. Implementations can also result in identifying and demoting lower-quality resources in a presentation order of search results in a search result page returned in response to a user's query. Thus, the user experience can be improved because search results higher in the presentation order provided in a search result page will better match the user's informational needs.

In some implementations, the described search system can be employed to detect exploitation of ranking signals used to provide a search result page by differentiating manipulated ranking signals from ranking signals for highly relevant results. In some implementations, the system is configured to provide and/or order search results in a search result page by determining that a value for a ranking signal is anomalously high when aggregated across a particular domain. In some cases, the search system separates domains having anomalous scoring (e.g., an anomalous information retrieval score) for a ranking signal(s) from domains having expected (e.g., typical) scoring for the ranking signal(s). For example, in some implementations, an aggregated difference, Z-Score, is used to flag domains that are exceptionally relevant for the queries for which they rank and that may be exploiting a search system or a particular pattern across the domain and not just in a single resource. More generally, a Z-Score is a statistical measure that quantifies the difference (or a distance) between a data point and the mean of a dataset. In the present disclosure, the mean may be an expected value of a ranking signal among historical search results (e.g., within search records), and the data point may be an information retrieval score for the ranking signal for resources of a domain.

In an example implementation, resources that are responsive to a query are processed by the search system. For example, the search system may be configured to review and analyze data from search records, i.e., records of previously provided search results. For each ranking signal used to determine search results for the query, the information retrieval scores of all resources responsive to a query are aggregated as an aggregate score. The aggregate score is used to determine an expected value for the information retrieval score for the ranking signal. Generally, the expected value reflects how well the attribute profile of the resource matches the predicted attribute profile of a resource with a similar information retrieval score for the particular ranking signal. For example, higher ranked documents are expected to have higher scores on each ranking signal, and in some cases, an expected value for a ranking signal is a function of the information retrieval score by which resources are ranked such that higher ranked resources are expected to have higher information retrieval score on each ranking signal. In some cases, a linear regression model of the aggregate score is used to determine the expected value of the information retrieval score for the ranking signal.

In some implementations, a difference, also referred to as a Z-score, between the expected value and the actual value of the information retrieval score of the ranking signal for a resource is determined. The difference (Z-Score) is aggregated, for each ranking signal, at the domain (site) level for each domain having at least one resource responsive to the query also referred to as a responsive domain. The aggregated differences provide a residual value, of the ranking signal, for the domain based on the positive and negative values in these measured differences.

In some cases, the residual value may indicate that the resource publisher for a domain is exploiting the ranking signal based on a comparison to a threshold value. Outlier domains include domains that are detected as outliers for a ranking signal (e.g., according to the residual value of the aggregated Z-scores and a threshold). In some cases, for example, resources from outlier domains are demoted in search results by having the associated ranking signal brought back to trend (e.g., the expected value) when responsive to a query (based on the ranking signal). In some implementations, a ranking signal is brought back to trend, for resources in a domain. For example, the difference for the respective ranking signal is determined for other resources in the domain based on these resources being responsive to a number of other queries, which can include the original query.

### Example Environment

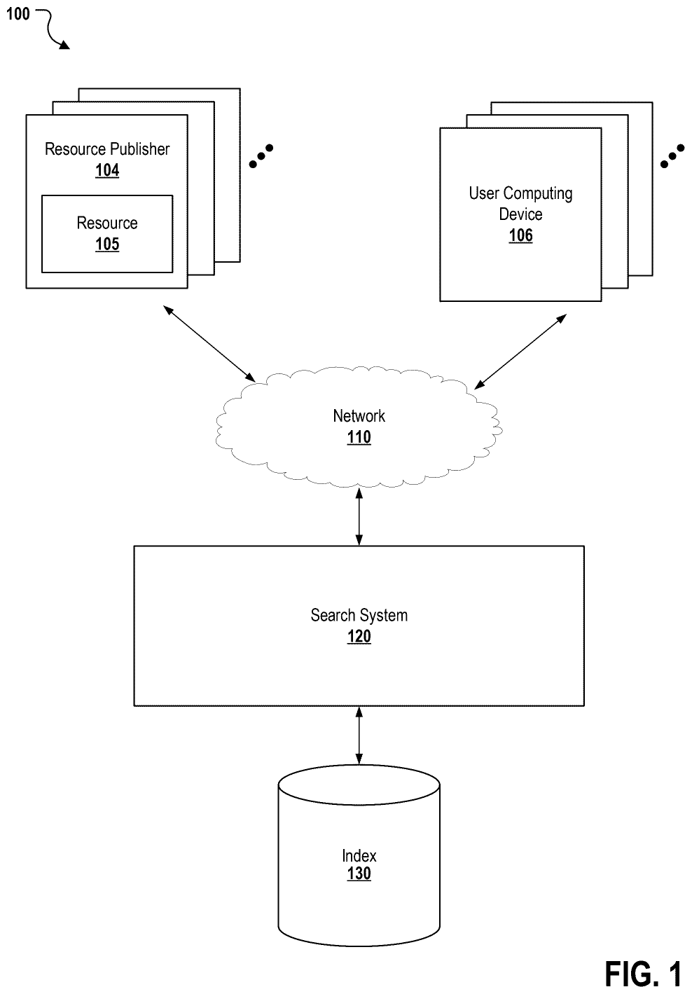

FIG. 1 is a block diagram of an example architecture 100 in which exploitation of ranking signals are detected. As depicted, a communications network 110 connects resource publishers 104, user computing devices 106, and a search system 120. The communication network 110 may include wireless and wired portions. In some cases, the communication network 110 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communication network 110 may also include future developed networks. In some implementations, the communication network 110 includes the Internet, an intranet, an extranet, or an intranet and/or extranet that is in communication with the Internet. In some implementations, the communication network 110 includes a telecommunication or a data network.

In some implementations, the resource publishers 104 publish resources 105. The resources 105 include, for example, web resources, documents such as a web page, and the like. In some cases, a resource publisher 104 is associated with a domain and hosted by one or more servers in one or more locations. In some cases, these one or more servers include a server-class hardware type device and/or computer systems using clustered computers and components to function as a single pool of seamless resources when accessed through the communication network 110. For example, such implementations may be used in data center, cloud computing, storage area network (SAN), and network attached storage (NAS) applications. In some implementations, the one or more servers are deployed using a virtual machine(s).

In some cases, the resource publishers 104 publish the resources 105 via a website. Such a website may include a collection of web resources 105. A web resource (e.g., a web page) includes data that can be provided over the communication network 110 via a resource address (e.g., a uniform resource locator (URL)). In some cases, the web resources 105 are formatted in a markup language (e.g., hypertext markup language (HTML), extensible markup language (XML), and the like). Web resources 105 may include, for example, text, images, multimedia content, programming elements, and the like. Other example web resources include, but are not limited to, images files, video files, audio files, feed sources, and the like. In some cases, the web resources 105 include embedded information such as metadata information, hyperlinks, embedded instructions (e.g., scripts) and the like.

In some implementations, the search system 120 accesses an index 130 to search resources 105. In some implementations, the index 130 includes a datastore of resources 105 generated by crawling the information (e.g., web sites) provided by the resource publisher 104. In some implementations, the index 130 is a repository for persistently storing and managing collections of data. Example data stores, such as the index 130, that may be employed within the described system include data repositories, such as a database as well as simpler store types, such as files, emails, and so forth. In some implementations, the search index 130 includes a database. In some implementations, a database is a series of bytes or an organized collection of data that is managed by a database management system (DBMS).

In some implementations, user computing device(s) 106 is an electronic device capable of requesting and receiving resources over the computer network 110. In some implementations, user computing device 106 is sustainably similar to the computing device 300. Example user computing devices 106 include personal computers, mobile communication devices, tablet computers, Extended Reality (XR) devices, and the like. The user computing devices 106 may include (e.g., may each include) any appropriate type of computing device, such as a desktop computer, a laptop computer, a handheld computer, a tablet computer, a personal digital assistant (PDA), an augmented reality (AR)/virtual reality (VR) device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the user computing devices 106 are configured to submit search queries to the search system 120 (e.g., via a web service provided by the search system 120). In some implementations, in response to each query, the search system 120 is configured to identify resources that are relevant to the query from the information stored in the index 130. For example, the search system 120 may, for example, identify the resources 105 in the form of search results. Once generated, the search results are provided as part of a search result page to the user device 106 from which the query was received.

A resource search result is data generated by the search system 120 that identifies a resource and provides information that satisfies a particular search query. A resource search result for a resource can include a web page title, a snippet of text extracted from the resource, and a resource locator for the resource (e.g., the URL). In some implementations, the search system 120 determines a residual value (also referred to herein as a standardized linear residual) for a domain based on an aggregate of a measured difference, i.e., a Z-score, between information retrieval scores of ranking signals for resources and an expected value that is determine for the information retrieval score for each ranking signal used to determine responsive resources to a particular query. In some examples, an information retrieval score for a resource may be generated based on the number, location, and/or characteristic (e.g., font, size, color, and the like) of occurrences of a search term in the resource. In some implementations, the search system 120 determines the standardized linear residual by fitting a line (e.g., constructing a straight line that has the best fit to a series of data points) from the log of the information retrieval score to the Z-score of the log of the ranking signal.

In some implementations, the search system 120 determines the scoring for ranking signals for resources by excluding outlier domains from scoring models used to determine a reasonable or typical value for a signal. For example, a regression coefficient employed in a scoring model may be constrained to non-negative values to ensure that the demotions of a domain does not cause ranking to be non-monotonic in the ranking signal. In some implementations, once the linear model is fit, domains that are determined as outliers (e.g., based on the residual value of the aggregated Z-scores) for a ranking signal are demoted by having information retrieval score for that ranking signal brought back to trend using, for example, a function of the information retrieval score aggregated at the domain level to scale the demotion. This demotion ensures that outlier domains do not receive a benefit from exploited ranking signals but instead resources from the domain are provided and/or ranked in a search result page according to expected (e.g., typical) values for each exploited ranking signal.

As an example, the search system 120 may determine a search ranking based on a raking score determined according to a function f, applied to ranking signals A, B, C, D. To determine whether a domain is an outlier for a ranking signal for a particular query, the search system 120 may determine an information retrieval score for each raking signal according to a linear model from the output of a final function using linear regression of the form y=a*x+b (e.g., A˜a*f(A,B,C,D)+b) where a is the slope of the residual and b is the bias. In some cases, a and b are determined (learned) based on data included in historical search records. Given such a linear model, the search system 120 can determine the residual r value for each ranking signal for each resource (e.g., document) as r=A−(a*f(A,B,C,D)+b). The search system 120 may then average that residual over the domain to determine whether the domain is an outlier in general (e.g., as compared to a threshold) and thus likely to be abusing ranking signals. For a domain, the residual average should be small because the positive and negative values in these measured differences cancel each other out. A domain that exploits a ranking signal has consistently high (positive) values for the signal and therefore has a large average residual. This large residual average for a domain is therefore indicative of an exploit.

The example provided in Table 1 show example rankings for four example domains R1-R4:

TABLE 1

| | Ranking (decreasing) | Signal | Residual |
|---|---|---|---|
| R1 | 1.5 | −0.9 | −0.517 |
| R2 | 0.06 | 0.3 | 0.345 |
| R3 | −0.47 | 1.5 | 1.378 |
| | | (outlier) | |
| R4 | −1.1 | −0.9 | −1.206 |

In the example of Table 1, the residual function is defined according to the linear regression (e.g., ranking*coefficient+residual value˜signal) and the coefficient is −0.27.

In some implementations, the search system 120 excludes search results for a navigational query from the aggregation because the ranking signals used to determine such results are not informative to probable signals abuse by a domain. Generally, a navigational query includes a search query entered with the intention of finding a particular website or webpage. Put another way, a query is considered navigational when a particular result is expected to receive a majority of the traffic originating from the query. A navigational result is the particular website or webpage responsive to a navigational query.

### Example Process

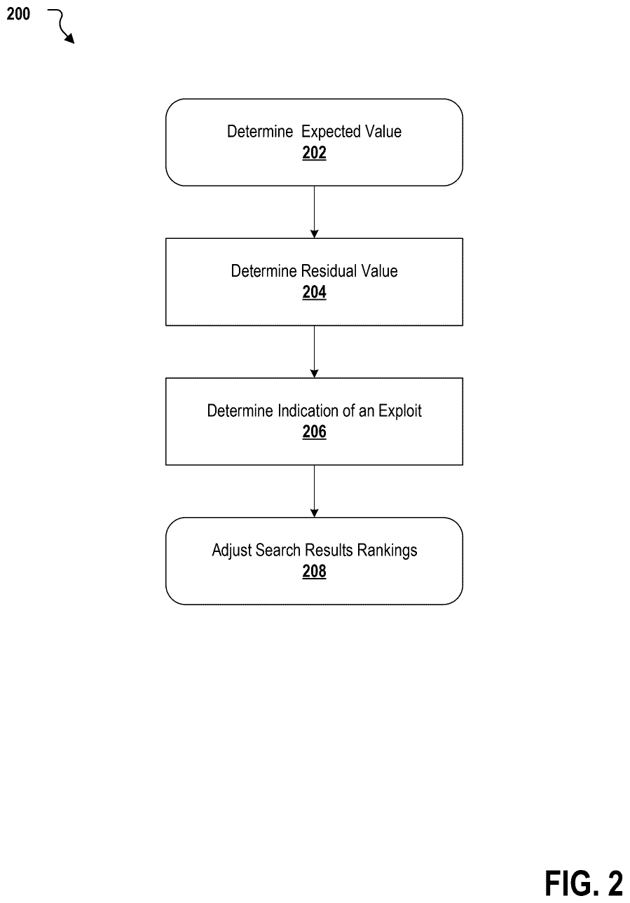

FIG. 2 depicts a flowchart of an example process 200 that can be implemented by implementations of the present disclosure. The example process 200 can be implemented by systems and components described with reference to FIG. 1. The example process 200 generally shows in more detail how exploitation of ranking signals by a domain are detected.

For clarity of presentation, the description that follows generally describes the example process 200 in the context of FIG. 1. However, it will be understood that the process 200 may be performed, for example, by any other suitable system, environment, software, and hardware, or a combination of systems, environments, software, and hardware as appropriate. In some implementations, various operations of the process 200 can be run in parallel, in combination, in loops, or in any order.

At 202, an expected value for a ranking signal is determined based on a plurality of first resources responsive to a query. In some implementations, each of the plurality of first resources meets a responsiveness threshold for the first query. In some implementations, the ranking signal is derived from content included in the plurality of first resources. This content is configurable by the respective resource publishers. In some cases, the expected value for the ranking signal is determined based on an aggregate score. In some cases, the aggregate score is determined based on the plurality of first resources responsive to the query. In some cases, the aggregate score is determined by aggregating the respective information retrieval scores for the ranking signal associated with each of the plurality of first resources responsive to the first query. In some implementations, the expected value is determined based on a linear regression model of the aggregate score. In some implementations, the linear regression model includes a regression coefficient that is constrained to non-negative values.

From 202, the process 200 proceeds to 204 where a residual value is determined by aggregating a difference between the expected value for the ranking signal for the first query and an information retrieval score for the ranking signal of a plurality of second resources provided via a domain. In some cases, the plurality of second resources includes at least one of the plurality of first resources.

From 204, the process 200 proceeds to 206 where the residual value being indicative of an exploit of the ranking signal on the domain is determined. In some cases, the residual value is indicative of the exploit based on a threshold value of the ranking signal across a plurality of second resources. In some cases, the plurality of second resources includes the at least one of the plurality of resources.

From 206, the process 200 proceeds to 208 where responsive to determining the residual value is indicative of an exploit, a ranking of a resource is adjusted. The resource being associated with the domain and being responsive to a second query based on the ranking signal. In some cases, the ranking is used to determine a position of the resource in the search result page and/or whether to return the resource as a search result in the search result page. In some implementations, the ranking of the resource is adjusted by assigning the expected value to the information retrieval score of the ranking signal.

In some implementations, the search result page includes a plurality of third resources that are responsive to the second query. In some implementations, the plurality of third resources includes the resource. In some implementations, the ranking of plurality of third resources in the search result page is determined based on respective ranking scores. In some implementations, the respective ranking scores are determined according to a function applied to a plurality of ranking signals. In some implementations, the plurality of ranking signals includes the ranking signal. In some implementations, the search result is provided as a response for the second query. In some implementations, the first query or the second query is not a navigational query. In some implementations, the second query is the first query. From 208, the process 200 ends or repeats, for example for another ranking signal.

### Example System

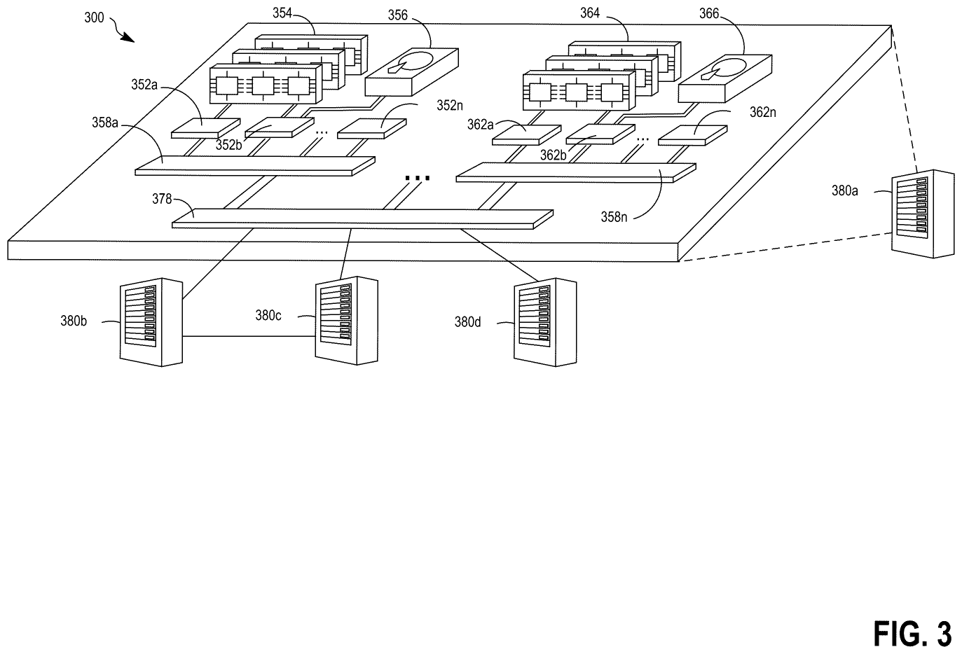

FIG. 3 shows an example of a computing device 300, which may be search system 120 of FIG. 1, which may be used with the techniques described here. The example computing device 300 can be programmed or otherwise configured to implement systems or methods of the present disclosure. Computing device 300 is intended to represent various example forms of large-scale data processing devices, such as servers, blade servers, data centers, mainframes, and other large-scale computing devices. Computing device 300 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 300 may be a distributed system that includes any number of computing devices 380 (e.g., 380a, 380b, . . . 380n). Computing devices 380 may include a server or rack servers, mainframes, and the like. communicating over a local or wide-area network, dedicated optical links, modems, bridges, routers, switches, wired or wireless networks, etc.

In some implementations, each computing device may include multiple racks. For example, computing device 380a includes multiple racks (e.g., 358a, 358b, . . . , 358n). Each rack may include one or more processors, such as processors 352a, 352b, . . . , 352n and 362a, 362b, 362n. The processors may include data processors, network attached storage devices, and other computer-controlled devices. In some implementations, one processor may operate as a master processor and control the scheduling and data distribution tasks. Processors may be interconnected through one or more rack switches 362a-362n, and one or more racks may be connected through switch 378. Switch 378 may handle communications between multiple connected computing devices 300.

Each rack may include memory, such as memory 354 and memory 364, and storage, such as 356 and 366. Storage 356 and 366 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 356 or 366 may be shared between multiple processors, multiple racks, or multiple computing devices and may include a non-transitory computer-readable medium storing instructions executable by one or more of the processors. Memory 354 and 364 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 354 may also be shared between processors 352a-352n. Data structures, such as an index, may be stored, for example, across storage 356 and memory 354. Computing device 300 may include other components not shown, such as controllers, buses, input/output devices, communications modules, and the like.

An entire system may be made up of multiple computing devices 300 communicating with each other. For example, device 380a may communicate with devices 380b, 380c, and 380d, and these may collectively be known as search system 120. Some of the computing devices may be located geographically close to each other, and others may be located geographically distant. The layout of computing device 300 is an example only and the system may take on other layouts or configurations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICS (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
determining an expected value for a ranking signal based on a plurality of first resources responsive to a first query;
determining a residual value by aggregating a difference between the expected value and an information retrieval score for the ranking signal of a plurality of second resources provided via a domain, wherein the plurality of second resources includes at least one of the plurality of first resources;
determining that the residual value is indicative of an exploit of the ranking signal on the domain; and
responsive to determining the residual value is indicative of an exploit, adjusting a ranking of a resource in a search result page, the resource being associated with the domain and being responsive to a second query based on the ranking signal.

2. The method of claim 1, wherein adjusting the ranking of the resource in the search result page includes:
assigning the expected value to the information retrieval score.

3. The method of claim 2, wherein the ranking signal is derived from content included in the resource that is configurable by a resource publisher.

4. The method of claim 1, wherein determining the expected value includes:
determining an aggregate score by aggregating the information retrieval score for the ranking signal associated with each of the plurality of first resources responsive to the first query; and
determining the expected value based on a linear regression model of the aggregate score.

5. The method of claim 4, wherein the linear regression model includes a regression coefficient that is constrained to non-negative values.

6. The method of claim 1, wherein the search result page includes a plurality of third resources responsive to the second query, wherein the plurality of third resources includes the resource, and wherein the ranking of the plurality of third resources in the search result page is determined according to respective ranking scores.

7. The method of claim 6, wherein the respective ranking scores are determined according to a function applied to a plurality of ranking signals, and wherein the plurality of ranking signals includes the ranking signal.

8. The method of claim 1, further comprising:
providing the search result page as a response for the second query.

9. The method of claim 1, wherein each of the plurality of first resources meets a responsiveness threshold for the first query.

10. The method of claim 1, wherein the residual value is indicative of the exploit based on a threshold value of the ranking signal across the plurality of second resources.

11. The method of claim 1, wherein the first query and the second query is not a navigational query.

12. The method of claim 1, wherein the second query is the first query.

13. A computer-readable medium storing instructions that when executed by an electronic processor cause the electronic processor to perform operations comprising:
determining an expected value for a ranking signal based on a plurality of first resources responsive to a first query;
determining a residual value by aggregating a difference between the expected value and an information retrieval score for the ranking signal of a plurality of second resources provided via a domain, wherein the plurality of second resources includes at least one of the plurality of first resources;
determining that the residual value is indicative of an exploit of the ranking signal on the domain; and
responsive to determining the residual value is indicative of an exploit, adjusting a ranking of a resource in a search result page, the resource being associated with the domain and being responsive to a second query based on the ranking signal.

14. The computer-readable medium of claim 13, wherein the operations to adjust the ranking of the resource further comprise assigning the expected value to the information retrieval score.

15. The computer-readable medium of claim 13, wherein the operations to determine the expected value further comprise:
determining an aggregate score by aggregating the information retrieval score for the ranking signal associated with each of the plurality of first resources responsive to the first query; and
determining the expected value based on a linear regression model of the aggregate score.

16. The computer-readable medium of claim 13, wherein the search result page includes a plurality of third resources responsive to the second query, wherein the plurality of third resources includes the resource, and wherein the ranking of the plurality of third resources in the search result page is determined according to respective ranking scores.

17. The computer-readable medium of claim 16, wherein the respective ranking scores are determined according to a function applied to a plurality of ranking signals, and wherein the plurality of ranking signals includes the ranking signal.

18. The computer-readable medium of claim 13, wherein the operations further comprise:
providing the search result page as a response for the second query.

19. A system comprising:
an electronic processor; and
a memory communicably coupled to the electronic processor and storing instructions that, when executed by the electronic processor, cause the system to:
determine an expected value for a ranking signal based on a plurality of first resources responsive to a first query;
determine a residual value by aggregating a difference between the expected value and an information retrieval score for the ranking signal of a plurality of second resources provided via a domain, wherein the plurality of second resources includes at least one of the plurality of first resources;
determine that the residual value is indicative of an exploit of the ranking signal on the domain; and
responsive to determining the residual value is indicative of an exploit, adjust a ranking of a resource in a search result page, the resource being associated with the domain and being responsive to a second query based on the ranking signal.

20. The system of claim 19, wherein the instructions, when executed by the electronic processor, that cause the system to adjust the ranking of the resource in the search result page, further cause the system to:
adjust the ranking of the resource in the search result page by assigning the expected value to the information retrieval score.
